(19) United States
(12) Patent Application Publication
(10) Pub. No.: US 2026/0320936 A1
(43) Pub. Date: Oct. 15, 2026

(54) IMAGE PROCESSING APPARATUS, IMAGE PROCESSING METHOD, AND STORAGE MEDIUM

(71) Applicant: CANON KABUSHIKI KAISHA, Tokyo (JP)

(72) Inventors: TAKAYUKI SUDO, Kanagawa (JP); KENZO HISA, Tokyo (JP)

(21) Appl. No.: 19/700,997

(22) Filed: Jun. 8, 2026

Related U.S. Application Data
(63) Continuation of application No. PCT/JP2024/043800, filed on Dec. 11, 2024.

(30) Foreign Application Priority Data
Dec. 25, 2023 (JP) 2023-218433

(51) Int. Cl. G06T 19/00; G06T 15/20; H04N 23/63

(52) U.S. Cl. CPC G06T 19/006; G06T 15/20; H04N 23/632

(57) ABSTRACT

An image processing apparatus generates a virtual space including a display region for displaying a shot image shot by a real space shooting unit for shooting a real space, and controls a shooting setting of the real space shooting unit in accordance with an operation instruction made by a user through an avatar in the virtual space.

### CROSS-REFERENCE TO RELATED APPLICATIONS

This application is a Continuation of International Patent Application No. PCT/JP2024/043800, filed Dec. 11, 2024, which claims the benefit of Japanese Patent Application No. 2023-218433, filed Dec. 25, 2023, both of which are hereby incorporated by reference herein in their entirety.

### BACKGROUND

### Field of the Technology

The present disclosure relates to an image processing method, an image processing apparatus, and a storage medium.

### Description of the Related Art

Conventionally, in virtual-space communication systems such as the metaverse, a user can configure an avatar (a character that represents themself) within a virtual space composed of three-dimensional (3D) graphics. Through their avatar, the user can perform various actions, such as communicating with other avatars (other users) in the virtual space. In systems for this type of virtual space communication, various techniques are being developed to link the virtual space with the real world and enable interaction between the two so that users can feel the experiences derived from controlling their avatars as if they were the users'own actions. One such technique is a technique in which a user controls their avatar in the virtual space to perform photography in the virtual space with a sense of presence close to that of photography in the real world. In photography in a virtual space, processing is performed in which a part of a region in the virtual space is cut out as an image (Japanese Patent Laid-Open No. 2009-176025). Methods for cropping out the image include, for example, directly capturing and saving an image of the graphics displayed on the monitor screen of the user's terminal, from the avatar's viewpoint, and capturing and saving a part of a region of viewpoint video.

Meanwhile, a system is known in which a virtual object generated by a computer system for CG is composited with a video shot in the real world (“live-action video”, hereinafter) and displayed therewith in real time (Japanese Patent Laid-Open No. 2011-035638). Although Japanese Patent Laid-Open No. 2011-035638 discloses a technique for compositing CG within live-action video, there is also a technique for compositing live-action video within an image in a virtual space. For example, a technique such as replacing an image of a “window” region in a room present in a virtual space with a video of the “sky” in the real world, shot with a user's camera (that is, live-action video), is known.

However, in a virtual space that includes a region of live-action video, there are cases where the live-action video is too dark (or too bright), or the white balance is inappropriate, relative to the image of the virtual space. In such a case, the user may wish to change the exposure of the real camera in order to change the brightness of only the region of the live-action video. However, if the user is operating the real camera that is obtaining the live-action video during virtual space communication, they must repeat the process of removing their HMD, changing the exposure settings in the real camera, and putting the HMD back on to confirm the brightness of the virtual space. In other words, the user is forced to perform cumbersome tasks to operate the real camera during virtual space communication.

### SUMMARY

According to one aspect of the present disclosure, a technique is provided that enables a user, during virtual space communication, to easily set a shooting setting in a real camera that shoots an image of a real space to be displayed in a virtual space.

An image processing apparatus according to one aspect of the present disclosure comprises the following configurations. That is, it comprises:
a virtual space generating unit configured to generate a virtual space including a display region of a real space image, the real space image being obtained by a real space shooting unit configured to shoot a real space; and
a shooting control unit configured to control a shooting setting of the real space shooting unit in accordance with an operation instruction made by a user through an avatar in the virtual space.

Features of the present disclosure will become apparent from the following description of embodiments with reference to the attached drawings.

### BRIEF DESCRIPTION OF THE DRAWINGS

The accompanying drawings, which are incorporated in and constitute a part of the specification, illustrate embodiments of the disclosure and, together with the description, serve to explain principles of the disclosure.

FIG. 1 is a block diagram illustrating an example of the configuration of an image processing system.

FIG. 2 is a diagram illustrating an overhead view of a virtual space.

FIG. 3A is a diagram illustrating camera images from a real camera and a virtual camera.

FIG. 3B is a diagram illustrating camera images from a real camera and a virtual camera.

FIG. 3C is a diagram illustrating camera images from a real camera and a virtual camera.

FIG. 4 is a flowchart illustrating processing according to a first embodiment.

FIG. 5A is a diagram illustrating a camera image from after an instruction to change the brightness of a virtual camera has been made, along with a viewing image.

FIG. 5B is a diagram illustrating a camera image from after an instruction to change the brightness of a virtual camera has been made, along with a viewing image.

FIG. 5C is a diagram illustrating a camera image from after an instruction to change the brightness of a virtual camera has been made, along with a viewing image.

FIG. 6 is a flowchart illustrating processing according to a second embodiment.

FIG. 7A is a diagram illustrating an example of a UI of a virtual camera according to a third embodiment.

FIG. 7B is a diagram illustrating an example of a UI of a virtual camera according to the third embodiment.

FIG. 7C is a diagram illustrating an example of a UI of a virtual camera according to the third embodiment.

FIG. 8 is a flowchart illustrating processing for displaying a real-camera linkage selection button.

FIG. 9 is a flowchart illustrating processing for changing the brightness with respect to a virtual camera according to the third embodiment.

FIG. 10A is a diagram illustrating an example of the display of a UI of a virtual camera according to a fourth embodiment.

FIG. 10B is a diagram illustrating an example of the display of a UI of a virtual camera according to the fourth embodiment.

FIG. 11 is a flowchart illustrating processing for changing the exposure of a virtual camera according to the fourth embodiment.

FIG. 12 is a diagram illustrating an example of reference information displayed in a virtual camera according to the fourth embodiment.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### First Embodiment

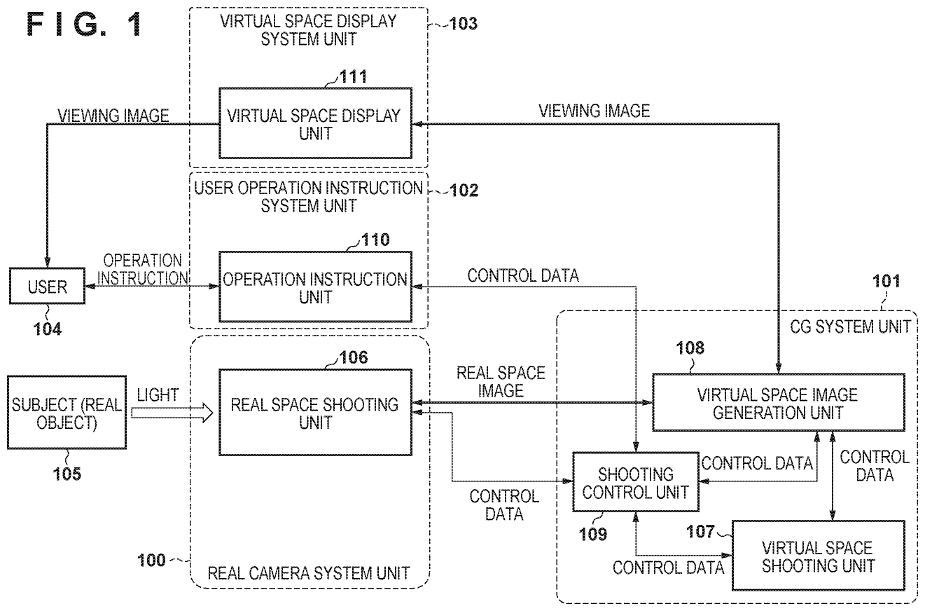

FIG. 1 is a block diagram illustrating an example of the configuration of an image processing system according to a first embodiment. The image processing system according to the first embodiment includes a real camera system unit 100, a CG system unit 101, a user operation instruction system unit 102, and a virtual space display system unit 103. Each of these system units may be constituted by a single apparatus, or may be constituted by a plurality of apparatuses. Alternatively, several of these system units may be realized by a single apparatus. The real camera system unit 100 shoots images in the real world. The CG system unit 101 is an image processing apparatus that generates a virtual space image through three-dimensional (3D) CG. CG is an acronym for “Computer Graphics”. The user operation instruction system unit 102 enables a user to make operation instructions for an object in a virtual space or to the real camera system unit 100 in the middle of virtual space communication. For example, the user can perform various operations in a virtual space through an avatar. The virtual space display system unit 103 displays an image for the user to monitor the virtual space (a viewing image) in a display apparatus such as a head-mounted display (HMD). The real camera system unit 100, the CG system unit 101, the user operation instruction system unit 102, and the virtual space display system unit 103 are connected by a communication interface capable of high-speed processing in order to communicate image information in real time.

In the present disclosure, “image” is used as a term collectively referring to video, moving images, and still images. Images shot by a real space shooting unit 106 and a virtual space shooting unit 107 are normally moving images, but may be still images instead. The following will describe an example in which the real space shooting unit 106 obtains moving images and the virtual space shooting unit 107 obtains still images. Note that there are no particular limitations on the image with respect to analog or digital type, the signal type of the data, the standard of specifications including whether the image is compressed or uncompressed, the recording apparatus, the recording medium, the recording time, and the like. Furthermore, the camera apparatus itself serving as the real space shooting unit 106, the shooting method thereof, and the like are not particularly limited.

### Real Camera System Unit 100

In the real camera system unit 100, the real space shooting unit 106 can shoot an image of a subject 105. The image shot by the real space shooting unit 106 is sent to a virtual space image generation unit 108 within the CG system unit 101 (described later). The real space shooting unit 106 includes, for example, a digital camera or a digital video camera (collectively referred to as a “real camera” hereinafter), and an interface for communicably connecting the real camera to the CG system unit 101. The real camera includes a lens unit capable of focus and zoom control, an image sensor such as a CMOS sensor, and an ND filter and an aperture stop for adjusting exposure. The real camera can set shooting settings (shutter speed, aperture value, gain (ISO sensitivity)) for adjusting the exposure (brightness) at the time of shooting. The real camera is also capable of shooting settings for adjusting the color during shooting (selecting image processing for adjusting the white balance (WB), hue, saturation, and tone). The real space shooting unit 106 can change at least one of the shooting settings described above in accordance with control data from a shooting control unit 109. However, the system according to the present embodiment is not limited to the apparatus configuration described above, and the configuration can be changed or apparatuses can be added as necessary.

Here, “user” refers to a person who operates the real space shooting unit 106 to shoot a real space image, and who controls an avatar, which is a character in the virtual space that represents the user themselves. After determining the exposure and angle of view (image range) of the real camera in advance, the user puts on an HMD or the like, controls the avatar and virtual camera, and performs various actions in the virtual space, including shooting images using the virtual camera.

### CG System Unit 101

The CG system unit 101 includes a 3D CG program and a computer equipped with a processor that runs the 3D CG program, and generates CG images in real time by executing the 3D CG program using the processor. The CG system unit 101 may, for example, provide a virtual-space communication system that constructs a virtual space (a virtual world) on the Internet to provide a place for users to engage in activities and communicate with each other. The virtual space shooting unit 107, the virtual space image generation unit 108, and the shooting control unit 109 provided in the CG system unit 101 are function blocks whose functions are realized by the stated computer. However, some or all of the virtual space shooting unit 107, the virtual space image generation unit 108, and the shooting control unit 109 may be realized by hardware such as dedicated ICs or the like.

The virtual space image generation unit 108 generates a virtual space that does not actually exist using data of a background, such as a wall of a room, for example, and generates the virtual space image. The virtual space image generation unit 108 also performs compositing processing in which a real space image sent from the real space shooting unit 106 (in this example, an image shot of the subject 105) is composited with the virtual space in a predetermined region of the virtual space to generate a new virtual space image. The virtual space image generation unit 108 can perform this compositing processing in real time. The virtual space image generation unit 108 also has a function for outputting the viewing image, which is an HMD image for viewing the virtual space, and a virtual camera image (still image) for recording using a virtual camera (described later). The virtual camera image is a cropped image obtained through processing in which a partial region of the virtual space is converted into two-dimensional (2D) image data and cropped out from the 3D virtual space data.

The virtual space shooting unit 107 receives the virtual camera image as one item of control data from the virtual space image generation unit 108. The virtual space shooting unit 107 has a function for adjusting image quality by applying digital gain to the received virtual camera image and changing the brightness and color (e.g., the WB). The virtual space shooting unit 107 then saves the virtual camera image for which the image quality has been adjusted to a storage apparatus inside the computer. As described above, the virtual space shooting unit 107 functions as a virtual camera. The virtual space shooting unit 107 also obtains, as control data, coordinate information pertaining to an insertion region of the real space image included in the cropped image (the virtual camera image) obtained from the virtual space image generation unit 108. This makes it possible for the virtual space shooting unit 107 to perform the processing using the stated digital gain on regions other than the insertion region of the real space image.

The shooting control unit 109 controls the real space shooting unit 106 including the real camera, or the virtual space shooting unit 107 including the virtual camera, in response to operation instructions made by the user in the user operation instruction system unit 102 (described later). The shooting control unit 109 can also simultaneously control the two shooting units, namely the real space shooting unit 106 and the virtual space shooting unit 107. The shooting control unit 109 instructs various shooting settings to be made in the real camera, such as setting the brightness (e.g., the exposure) of the image shot by the real camera, setting image processing pertaining to the color, tone, and image range, setting the zoom (angle of view), and the like. The shooting control unit 109 also instructs various shooting settings to be made in the virtual camera, such as setting the brightness of the virtual camera, setting image processing pertaining to the color, tone, and image range, setting the zoom (cropping range), and the like. The shooting control unit 109 can also obtain various types of information on the processing by the virtual space image generation unit 108, such as processing for compositing the real space image into the virtual space as performed by the virtual space image generation unit 108, the size and coordinate information of the insertion region of the real space image in the composite image, and the like.

### User Operation Instruction System Unit 102

An operation instruction unit 110 is a known input apparatus, such as a remote controller, a keyboard, or the like, through which the user controls the avatar, the virtual camera, or the like in the virtual space, or operates the real camera shooting in the real space. The operation instruction unit 110 is known technology and will therefore not be described in detail.

### Virtual Space Display System Unit 103

A virtual space display unit 111 is a display that displays a 3D image, and an HMD is used in the present embodiment. By wearing the HMD on their head, the user can view an image of the virtual space (the viewing image) including the real space image, generated by the CG system unit 101. The virtual space display system unit 103 is a known technology and will therefore not be described in detail. While confirming the image in the virtual space displayed in the virtual space display system unit 103, the user uses the user operation instruction system unit 102 to perform operations such as moving the avatar, changing the angle of view (image range) of the virtual camera, changing the brightness, and the like.

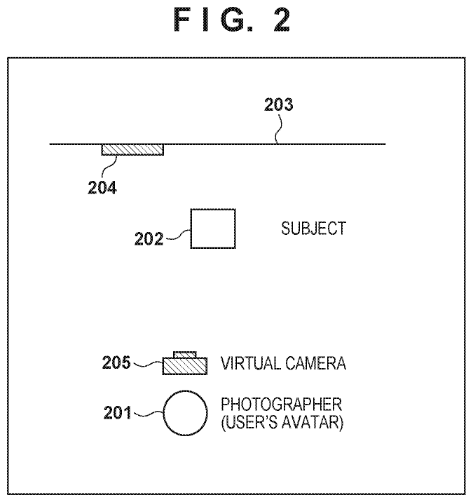

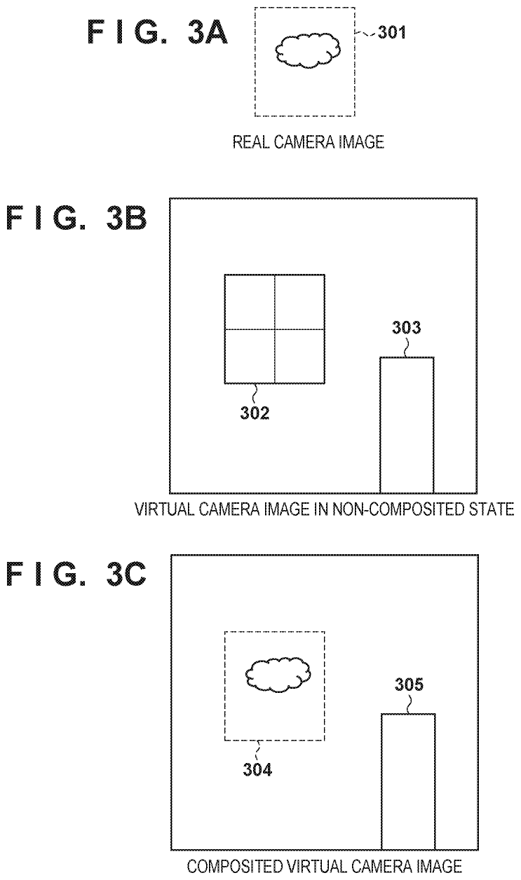

Processing performed in the system according to the present embodiment will be described next. In the present embodiment, when the shooting settings of the virtual camera are changed in response to a user operation, the shooting settings of the real camera are changed in coordination therewith. For example, when a user changes the brightness setting for shooting in the virtual camera, the exposure in the real camera is changed in accordance with the change in the brightness of the virtual camera. As an example, the following will describe a case where the exposure of the real camera is set one step darker in response to the user setting the brightness of the virtual camera one step darker. Changing the brightness of the virtual camera and changing the exposure of the real camera are examples of a shooting setting that can be made for the virtual camera and the real camera. A shooting scene shot by the virtual camera and the real camera will be described with reference to FIG. 2, which is an overhead view in the virtual space, and FIGS. 3A to C, which represent the shot images shot by the real camera and the virtual camera.

The shooting scene for the virtual camera, illustrated as an overhead view of FIG. 2, is a scene in which an avatar (a photographer 201) controlled by a user 104 uses a virtual camera 205 to shoot a subject 202 against a background, which is a wall 203 indoors having a window 204. The window 204 is a region of the virtual space into which an image shot by a real camera can be inserted. The shooting scene of the real camera is the sky as an example, as shown in the real space image 301 captured by the real camera in FIG. 3A. In other words, in this example, the subject 105 in FIG. 1 is the sky.

FIG. 3B illustrates a shot image shot by the virtual camera (the virtual camera image) in a state where the real space image obtained by the real camera has not been inserted into the virtual space. A window 302 in FIG. 3B corresponds to the window 204 existing in the wall in the virtual space, and is set as the insertion region for the real space image in this example. When the real space image is inserted at the position (region) of the window 302, the virtual camera image appears as illustrated in FIG. 3C. As indicated by the region 304 in FIG. 3C, the real space image 301 (the image of the sky) in FIG. 3A is displayed in the region of the window 302 (the insertion region for the real space image). An image 303 and an image 305 in FIGS. 3B and C, respectively, are images in which the subject 202 in the virtual space is displayed.

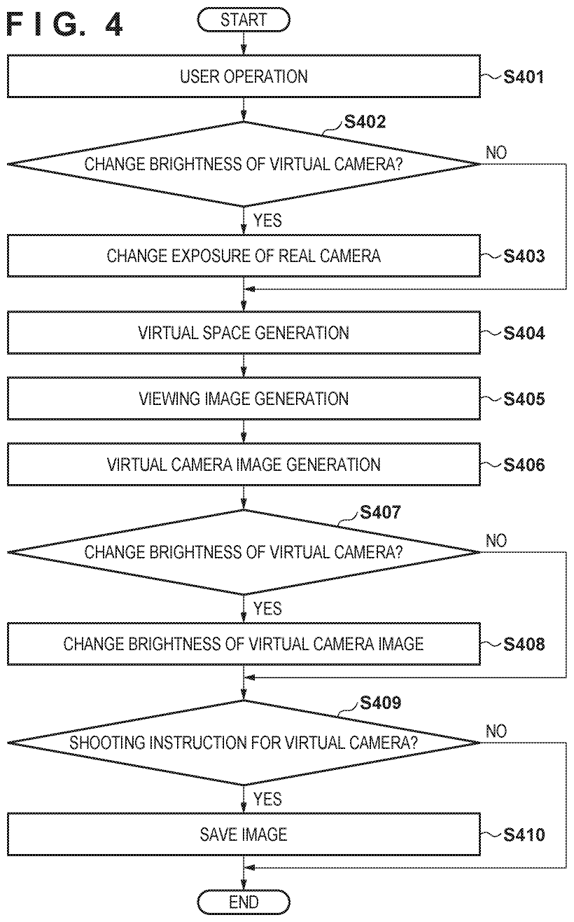

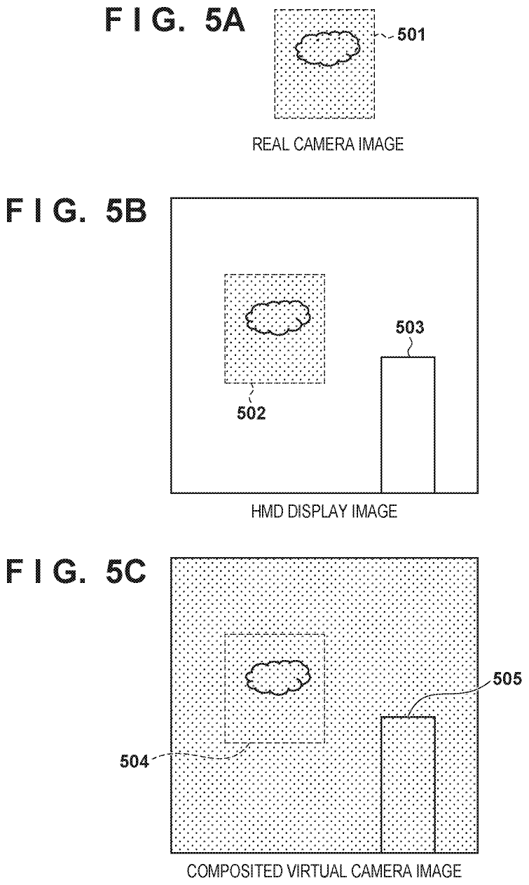

FIG. 4 is a flowchart illustrating an example of a processing sequence performed in the image processing system according to the present embodiment. FIGS. 5A to C are diagrams illustrating shot images from each camera after the virtual camera has been instructed to change its brightness, and viewing images in the virtual space displayed in the HMD, with respect to the shooting scene illustrated in FIGS. 3A to C. The flow of shooting processing when the virtual camera is instructed to change the brightness setting will be described next with reference to FIGS. 3A to 5C.

First, in S401, the user 104 operates the virtual camera using the operation instruction unit 110. For example, when the virtual camera is operated, the shooting control unit 109 determines a shooting angle of view in the virtual space. It is assumed here that the determination is made as illustrated in FIG. 3C. Next, in S402, the shooting control unit 109 determines whether the user 104 has made a change instruction, for changing the brightness of the shot image, for the virtual camera through the operation instruction unit 110. If a change instruction has been made (YES in S402), the sequence moves to S403, but if no change instruction has been made (NO in S402), the sequence skips S403 and moves to S404. In the present embodiment, it is assumed that an instruction to darken the shot image of the virtual camera by one step has been made by a user operation on the virtual camera. The sequence therefore moves to S403.

In S403, the shooting control unit 109 issues a change instruction to the real space shooting unit 106 to decrease the exposure by one step in response to the change instruction to darken the brightness by one step made for the virtual camera. For example, if the aperture of the real camera is set to F/8, the shooting control unit 109 issues an instruction to change the aperture to F/11, and the real space shooting unit 106 controls the aperture of the real camera in accordance with that instructed value. As a result, the real space image captured by the real camera is an image of the sky that is one step darker than the real space image 301 illustrated in FIG. 3A, such as a real space image 501 illustrated in FIG. 5A. Note that the exposure control parameter for changing the exposure is not limited to the aperture, and for example, shutter speed, ISO sensitivity, a combination thereof, and the like can be used, and is not particularly limited.

Next, in S404, the virtual space image generation unit 108 composites the real space image, in which the exposure has been changed, with the virtual space. Next, in S405, the virtual space image generation unit 108 generates the viewing image for display in the HMD. Although 3D images are normally used in the HMD, in the present embodiment, the image displayed in the HMD will be described as the 2D image illustrated in FIG. 5B in order to simplify the descriptions. At this time, the real space image of a region 502 corresponding to the window is an image of a dark sky. Next, in S406, the virtual space shooting unit 107 generates the virtual camera image by cropping the 2D image of the predetermined region out from the virtual space region as the shot image for the virtual camera.

Next, in S407, the virtual space shooting unit 107 determines whether an instruction to change the brightness of the virtual camera has been made, moves the sequence to S408 if an instruction to change the brightness has been made, and moves the sequence to S409 if not. As described above, in this example, a change instruction to darken the brightness of the virtual camera by one step is made, and the sequence therefore moves to S408. In S408, the shooting control unit 109 makes an instruction to change the brightness to the virtual space shooting unit 107 in response to the instruction to change the brightness made to the virtual camera. The virtual space shooting unit 107 changes the brightness of the virtual camera image by applying digital gain to the regions other than the insertion region of the real space image. As a result, as illustrated in FIG. 5C, an image in which both the region of the real space image and the region of the image in the virtual space have become one step darker relative to FIG. 3C is obtained.

In S409, the virtual space shooting unit 107 determines whether the user 104 has made a shooting instruction for the virtual camera. If a shooting instruction has been made (YES in S409), the sequence moves to S410. In S410, the virtual space shooting unit 107 saves the cropped image for which the brightness has been adjusted into the recording apparatus within the CG system unit 101. On the other hand, if no shooting instruction for the virtual camera has been made (NO in S409), the sequence ends.

As described above, in the first embodiment, the configuration is such that an instruction to change the exposure of the real camera is made in response to an instruction to change the brightness of the virtual camera, and thus an operation for adjusting the exposure of the real camera is unnecessary.

### Second Embodiment

The first embodiment described a configuration in which the exposure control of the real camera changes in coordination with a brightness instruction for the virtual camera. However, when the operation exemplified in the first embodiment (the operation of lowering the brightness by one step with respect to the virtual camera) is performed, due to the linkage of the exposure control of the real camera, in the image displayed on the HMD (the viewing image), as illustrated in FIG. 5B, only the region 502 in which the real space image is displayed becomes dark. There are thus situations where the user viewing the viewing image experiences a sense of unnaturalness when a partial region of the viewing image (the region of the real space image) darkens as a result of the operation made on the virtual camera. To address this issue, in the second embodiment, variations in the brightness of the real space image in the viewing image displayed in the HMD are reduced. This makes it possible to keep the brightness of the real space image in the viewing image in, or bring it close to, the state prior to when the virtual camera was operated, and the above-described sense of unnaturalness can be eliminated.

In the second embodiment, the basic configuration of the image processing system is the same as in the first embodiment (see FIG. 1). The shooting scenes for the real camera and the virtual camera are the same as in the first embodiment, and are assumed to be examples of scenes in which an image one step darker is shot by the virtual camera. The following will primarily describe areas that are different from the first embodiment.

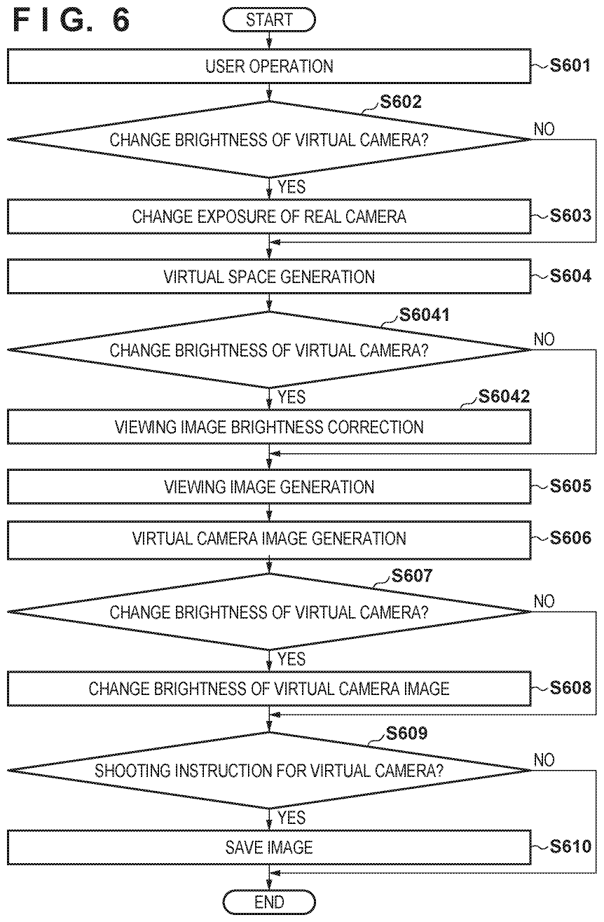

Shooting processing by the virtual camera according to the second embodiment will be described with reference to FIG. 6. FIG. 6 is a flowchart illustrating shooting processing performed according to the second embodiment, where S601 to S610 in FIG. 6 correspond to S401 to S410 in the first embodiment (FIG. 4), respectively. In other words, the differences between FIGS. 4 and 6 are S6041 and S6042; the other steps are the same as in the first embodiment, and will therefore not be described here.

In S6041, the virtual space image generation unit 108 determines whether an instruction to change the brightness has been made to the virtual camera. If an instruction to change the brightness of the virtual camera has been made (YES in S6041), the sequence moves to S6042, whereas if no instruction to change the brightness of the virtual camera has been made (NO in S6041), the sequence skips S6042 and moves to S605. In S6042, in response to the instruction to change the brightness of the virtual camera, the shooting control unit 109 increases the brightness of the display region of the real space image in the viewing image to be displayed in the HMD by plus one step, through image processing such as digital gain, gamma, or the like. As a result, the amount of change in the exposure of the real camera performed in S603 (minus one step) is canceled, and the viewing image for the HMD generated in the next S605 can be kept in the state prior to the instruction to change the exposure of the virtual camera. In other words, the image of the region 502 illustrated in FIG. 5B becomes plus one step brighter, and a viewing image such as that illustrated in FIG. 3C is obtained.

As described above, according to the second embodiment, even if a shooting setting is changed in the real camera, a change in the image caused by the change to the shooting setting is reduced in the real space image displayed in the viewing image, making it possible to provide a viewing image that has no, or a reduced, sense of unnaturalness. Although the present embodiment has described a case where the display region of the real space image in the viewing image is corrected as an example, the present embodiment is not limited thereto. For example, the virtual space itself generated by the virtual space image generation unit 108 may be corrected. In this case, in the generation of the virtual space in S604, the brightness of the display region of the real space image is changed in accordance with the instruction to change the brightness of the virtual camera. For example, in response to the instruction to change the brightness of the virtual camera by minus one step, the virtual space is generated having changed the brightness of the display region of the real space image by plus one step, which makes the processing of S6042 unnecessary.

### Third Embodiment

In the first and second embodiments, configurations have been described in which the real camera is operated in coordination with a brightness operation on the virtual camera. However, there are cases where the operation of the virtual camera and the exposure control of the real camera are not necessarily desired to be linked, such as, for example, when only the appearance in the virtual camera is simply desired to be changed. Accordingly, the third embodiment will describe a configuration in which whether to link the operation of the virtual camera with the control of the real camera can be selected.

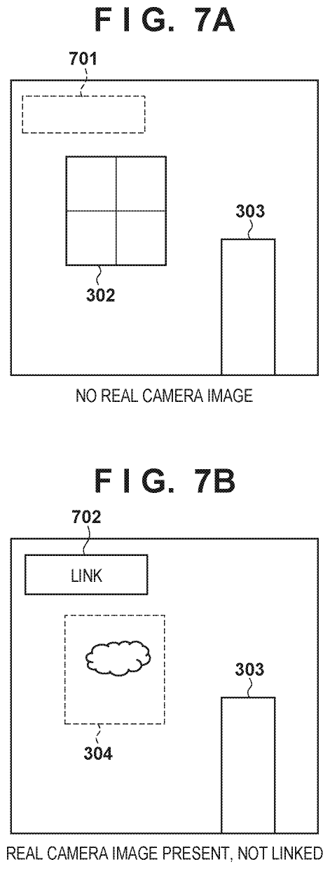

The basic configuration is the same as in the first embodiment (FIG. 1). The shooting scenes assumed are also the same as in the first embodiment (FIGS. 2 and 3A to C). Shooting processing according to the third embodiment will be described hereinafter with reference to FIGS. 7A to 9.

An example of a display of a user interface (“UI” hereinafter) of the virtual camera according to the third embodiment will be described first with reference to FIGS. 7A to C. FIG. 7A is an example of the display when the image of the real camera (the real space image) is not within the angle of view range of the virtual camera, whereas FIGS. 7B and 7C are examples of the display when the image of the real camera (the real space image) is within the angle of view range of the virtual camera. If the display region of the real space image is not within the angle of view range of the virtual camera, a button for instructing whether to link the real camera to changes in the exposure of the virtual camera (a “link button” hereinafter) is not displayed on the display (a state 701). However, if an image from the real camera is present, a link button 702 is displayed on the display. In the present example, the state in which the link button 702 is black text on a white background (FIG. 7B) indicates that the link button 702 is in an unselected state (a disabled state), and the real camera is not linked to the operation of the virtual camera. A state in which the link button 702 is white text on a black background (FIG. 7C) indicates that the link button 702 is in a selected state (an enabled state), and the real camera is linked to the operation of the virtual camera. The link button 702 switches between the selected state and the unselected state in response to the avatar touching the link button 702 as a result of a user operation, for example.

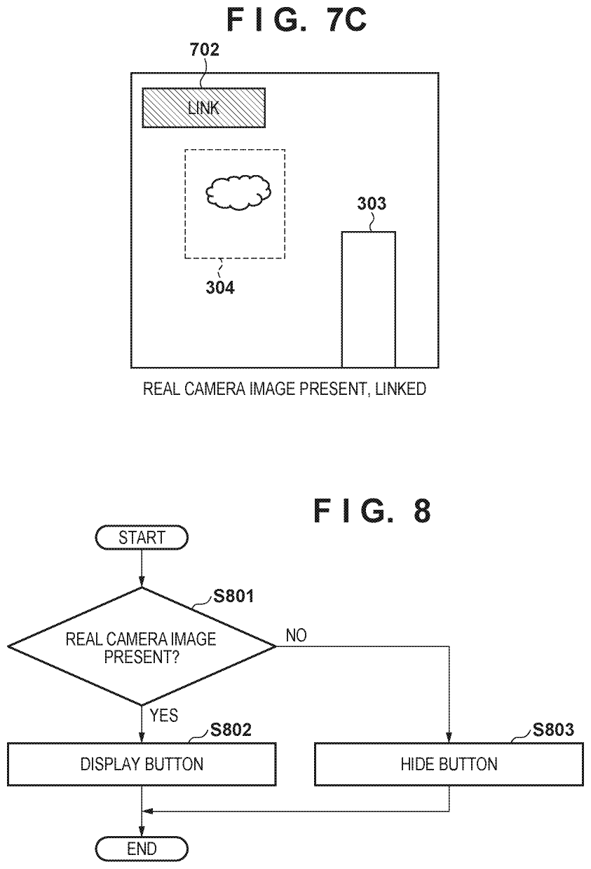

Processing for displaying the link button for specifying whether to link the real camera when changing the exposure of the virtual camera will be described with reference to FIG. 8. The virtual space image generation unit 108 determines whether an image shot using the real camera (the real space image) is present in the angle of view of the virtual camera when shooting with the virtual camera 205 (S801). Specifically, the coordinates of the range present in the angle of view of the virtual camera are calculated from the position and orientation of the virtual camera, and whether the real space image is present within that range is determined. If the determination indicates that the real space image is present within the angle of view of the virtual camera (YES in S801), the virtual space image generation unit 108 displays the link button 702 (S802). However, if the real space image is determined not to be present within the angle of view of the virtual camera (NO in S801), the virtual space image generation unit 108 does not display the link button 702 (S803). Accordingly, if the real space image is not present within the angle of view of the virtual camera, the processing for changing the shooting settings of the real space shooting unit 106 in response to the user operation on the virtual space shooting unit 107 is not performed.

It goes without saying that the display of the link button 702 is not limited to the example described above. For example, the display of the link button 702 when the image shot by the real camera is not in the angle of view of the virtual camera may be made a gray display to express that the link button 702 cannot be pressed (that the link button 702 is disabled). Alternatively, the selection of the linkage may be realized through a menu selection UI rather than the link button 702. In this case, when the image shot by the real camera is not in the angle of view of the virtual camera, a state in which linkage cannot be selected may be represented by making menu selection impossible. Any display is acceptable as long as the presence or absence of an image from the real camera can be known.

Additionally, even if the image shot by the real camera is within the angle of view of the virtual camera, the link button 702 may be hidden when the owner of the real camera does not permit operation or when the real camera does not have a function for executing linkage. For example, an ID of the real camera that is shooting the real space image included in the angle of view of the virtual camera may be obtained, information on whether the real camera can be operated may be determined from the obtained ID, and whether to display or hide (enable or disable) the link button may be determined in accordance with the result of determining whether the real camera can be operated. Accordingly, if the real space shooting unit 106 does not support or permit the control of the shooting settings by the shooting control unit 109, the processing for changing the shooting settings of the real space shooting unit 106 in response to the user operation on the virtual space shooting unit 107 is not performed. Also, the user can understand that the real space shooting unit 106 does not support or permit the control of the shooting settings by the shooting control unit 109 based on the display state of the link button 702.

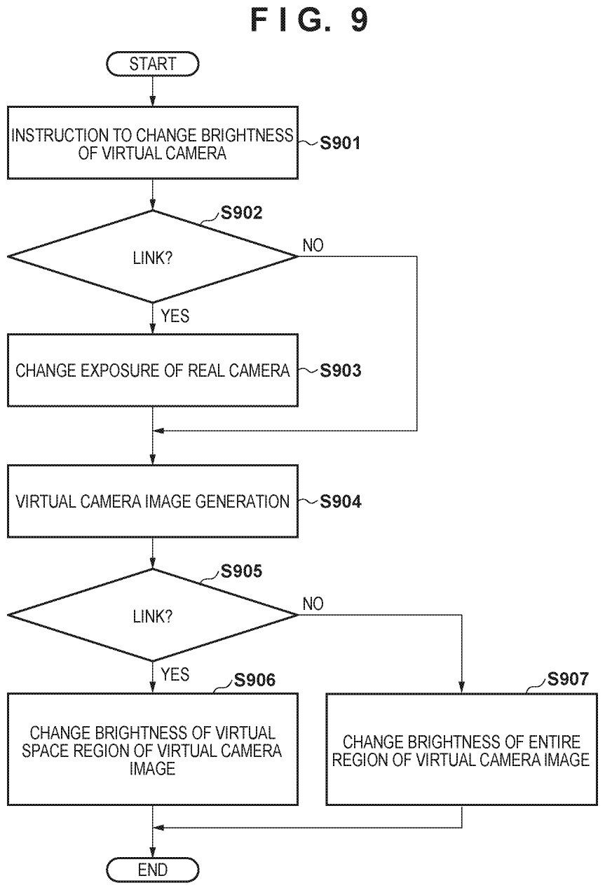

Processing for changing the brightness in the virtual camera according to the third embodiment will be described next with reference to the flowchart in FIG. 9. In S901, the shooting control unit 109 accepts an instruction to change the brightness of the virtual camera, made by the user through the avatar. In S902, the shooting control unit 109 determines whether the link button 702 is enabled. If the link button 702 is enabled (the state in FIG. 7C) (YES in S902), the shooting control unit 109 instructs the real space shooting unit 106 to change the exposure of the real camera in S903. The amount by which the exposure is changed at this time is an amount based on the change accepted in S901. On the other hand, if the link button 702 is disabled (the state in FIG. 7B) (NO in S902), the processing of S903 is skipped, and the exposure of the real camera is not changed.

Next, in S904, the virtual space image generation unit 108 generates an image of the angle of view of the virtual camera from information about the virtual space. In S905, the virtual space shooting unit 107 determines the state of the link button 702. If the link button 702 is enabled (the state in FIG. 7C) (YES in S905), the sequence moves to S906. In S906, the virtual space shooting unit 107 changes the brightness of the region of the virtual camera image generated from the virtual space (the region excluding the region of the real space image) in accordance with the change instruction received in S901. On the other hand, if the link button 702 is disabled (the state in FIG. 7B) (NO in S905), the sequence moves to S907. In S907, the virtual space shooting unit 107 changes the brightness of the entire region of the virtual camera image in accordance with the change instruction received in S901 (S907).

As described above, in the third embodiment, whether to perform an operation for the exposure of the real camera can be selected based on an instruction to change the brightness of the virtual camera and the pressing state of the link button. In other words, whether to change the shooting settings of the real camera in coordination with changes in the shooting settings of the virtual camera can be selected.

### Fourth Embodiment

In the third embodiment, the brightness of the virtual camera image is changed according to S906 or S907 in FIG. 9. In other words, the overall brightness of the virtual camera image changes in response to the instruction pertaining to the brightness of the virtual camera, regardless of the state of the link button 702. However, there are cases where the brightness is to be changed only for the real camera or the virtual camera, such as when there is a brightness difference between the real space image from the real camera and the virtual camera image, when blown-out highlights or blocked-up shadows are present in the real space image from the real camera, and the like. The fourth embodiment will describe an example of a configuration for selecting which of the shooting settings of the real camera and the virtual camera is to be changed in response to an operation on the virtual camera.

In the fourth embodiment, the basic configuration of the image processing system is the same as in the first to third embodiments. The shooting scene assumed is also as illustrated in FIGS. 2 and 3A to C. The following will primarily describe areas of the fourth embodiment that are different from the third embodiment.

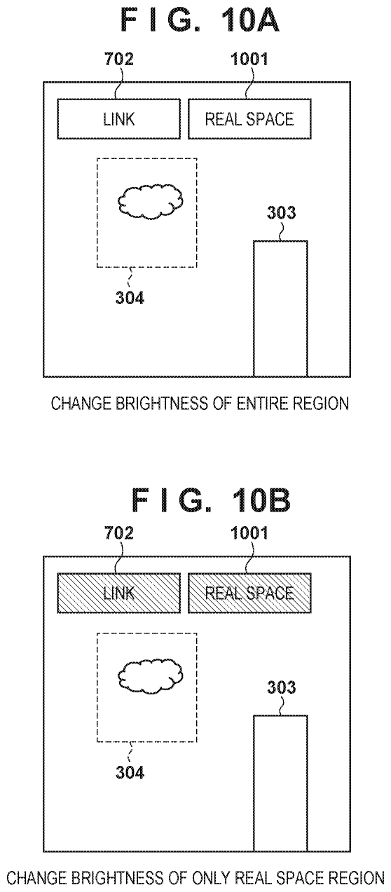

FIGS. 10A and B are diagrams illustrating an example of the display of a UI of the virtual camera according to the fourth embodiment. The UI of the virtual camera according to the fourth embodiment includes a real space button 1001 in addition to the link button 702 illustrated in FIGS. 7B and C. The real space button 1001 is a button for selecting whether the region where the image is to change in response to the virtual camera being operated is to be set to only the image of the real space. For example, if the real space button 1001 is disabled when the brightness setting of the virtual camera is changed (FIG. 10A), the overall brightness of the image obtained by the virtual camera changes. On the other hand, if the real space button 1001 is enabled (FIG. 10B), the brightness changes only in the part corresponding to the image of the real space. Note that like the link button 702, the real space button 1001 is displayed when the display region of the real space image from the real camera is present within the angle of view of the virtual camera. In other words, whether to display or hide the real space button 1001 is controlled in S802 and S803 in FIG. 8. Alternatively, like the link button 702, whether to display or hide the real space button 1001 may be controlled based on whether the real camera supports changing the shooting settings from the shooting control unit 109.

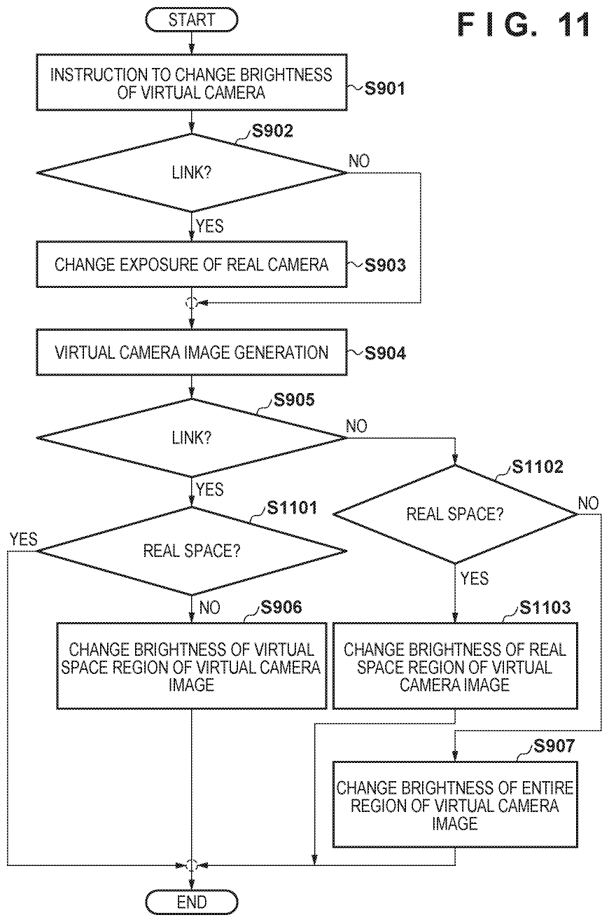

FIG. 11 is a flowchart illustrating processing for changing the brightness of the virtual camera according to the fourth embodiment. The processing of S901 to S904 is the same as in the third embodiment (FIG. 9). In other words, when the brightness of the virtual camera is instructed to be changed, the shooting control unit 109 changes the exposure of the real camera if the link button 702 is enabled (S901 to S903). The virtual space shooting unit 107 then generates the virtual camera image, which is the image shot by the virtual camera (S904).

In S905, the virtual space shooting unit 107 determines the state of the link button 702. If the link button 702 is enabled (YES in S905), the sequence moves to S1101. In S1101, the virtual space shooting unit 107 determines the state of the real space button 1001. If the real space button is enabled (YES in S1101), the processing ends directly. As a result, the brightness is changed only in the display region of the real space image in the virtual camera image. In this case, the exposure of the real camera has already been changed in S903, and the brightness of the real space image in the virtual camera image has changed to the desired brightness. On the other hand, if the real space button is disabled in S1101 (NO in S1101), the sequence moves to S906 in order to change the brightness of the entire region of the virtual camera image. If the real space button 1001 is determined to be disabled in S1101, the instruction is an instruction to change the brightness of the entire region of the virtual camera image in the state where the exposure of the real camera has been changed (S903). As such, the virtual space shooting unit 107 changes the brightness only for the virtual space region where the brightness has not been changed in the virtual camera image (S906).

If the link button 702 is determined to be disabled in S905 (NO in S905), the sequence moves to S1102. In S1102, the virtual space shooting unit 107 determines whether the real space button 1001 is enabled. If the real space button 1001 is enabled (YES in S1102), the sequence moves to S1103. In this case, the exposure of the real camera has not been changed (S903 has been skipped), and thus in S1103, the virtual space shooting unit 107 changes the brightness of only the display region of the real space image. This processing can be used when, for example, the balance between the brightnesses of the real space and the virtual space is to be changed in a state where the exposure of the real camera is not permitted to be changed. On the other hand, if the real space button 1001 is disabled (NO in S1102), the sequence moves to S907. Since the exposure of the real camera has not been changed as described above, the virtual space shooting unit 107 changes the brightness of the entire region of the virtual camera image, including the display region of the real space image (S907).

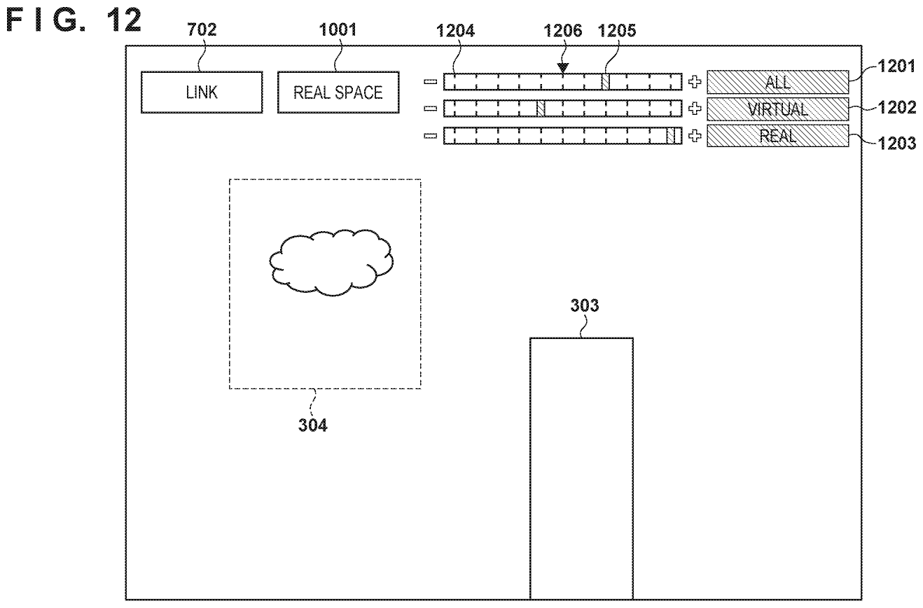

Note that reference information that can be referred to when the user operates the link button 702 and the real space button 1001 may be displayed in the UI of the virtual camera, for example. An example of displaying reference information for the brightness of the virtual camera according to the fourth embodiment will be described next with reference to FIG. 12. The brightness reference information is displayed so that the user can determine whether to change the brightness of only the display region of the image of the real space, the brightness of only the display region of the image of the virtual space, or the brightness of the entire region. Reference information 1201 indicates the brightness of the image of the entire region, reference information 1202 indicates the brightness of the image of the virtual space (the image other than the region 304), and reference information 1203 indicates the brightness of the image of the real space (the image of the region 304). A scale 1204 is a brightness scale, and in this example, one mark represents 0.5 steps. A cursor 1205 indicates the brightness of the respective images, and a correct position 1206 is a position when the brightness is correct. When the cursor 1205 is at the correct position 1206, the image is at the correct brightness. When the cursor is to the right of the correct position 1206, the brightness is too high, whereas when the cursor is to the left of the correct position 1206, the brightness is too low.

The brightness reference information is calculated, for example, by the shooting control unit 109 obtaining luminance information of the images obtained by the real space shooting unit 106 and the virtual space shooting unit 107, and calculating a number of steps in the difference between the respective average luminance values and a correct luminance value determined in advance. For example, assuming that the average luminance value of the images is Y and the average luminance value of the correct brightness is Yc, a number of steps in the difference ΔY is calculated as:

ΔY=log₂(Y/Yc)

The shooting control unit 109 determines the position of the cursor 1205 in accordance with the calculated value. Position information of the cursor, determined by the shooting control unit 109, is sent to the virtual space image generation unit 108. The virtual space image generation unit 108 moves the cursor 1205 to a position in the UI of the virtual camera based on the position information, composites the information as the brightness reference information with the image of the virtual space, and displays the result in the virtual space display unit 111. In the example in FIG. 12, the image of the virtual space is 0.5 steps underexposed, the image of the real space is 2.5 steps overexposed, and the entire image is 1 step overexposed. With this information in mind, the user can determine whether to change the exposure of the real camera, the brightness of the image of the virtual camera, and the like, and determine the state of the link button 702 and the real space button 1001.

Note that as long as the brightnesses of the images in the respective regions can be compared, the brightness reference information is not limited to the example described above. For example, a difference from a correct Bright Value (BV) of the images of the respective regions may be displayed as a numerical value, or the correct BV values and the BV values of the respective images may be displayed.

In addition, changing the exposure of the camera in the real space may ameliorate blown-out highlights and blocked-up shadows, depending on the brightness of the subject, and thus a histogram or the like may be displayed, and information of blown-out highlights and blocked-up shadows may be displayed. This display may be limited to the image of the real space, and the user can confirm the state of blown-out highlights and blocked-up shadows from the displayed histogram, and then determine the exposure of the real camera.

Although the present embodiment describes an example in which only the image region of the real space is changed, the configuration may be such that only the image region of the virtual space can be selected to be changed, or such that both can be selected. The configuration for the selection in this case may be any configuration in which a change can be made after specifying a region, and is not limited in any way.

As described above, according to the image processing system of the present embodiment, it is possible to change the exposure of the real camera, the brightness of each region of the virtual camera, or the brightness as a whole, in accordance with an operation on the brightness of the camera in the virtual space. The brightness of each region and the overall brightness can also be changed while referring to the reference information.

Although the aforementioned first to fourth embodiments described shooting settings related to the brightness of an image as an example of shooting settings made by the virtual camera and the real camera in coordination with each other, the embodiments are not limited thereto, and the linkage according to the embodiments can be applied to a variety of shooting settings in the real camera. For example, the shooting settings to be linked may be settings related to at least one of image processing for adjusting the color (WB, hue, and saturation) of the shooting, and image processing for adjusting the tone.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

1. An image processing apparatus comprising:
a virtual space generating unit configured to generate a virtual space including a display region of a real space image, the real space image being obtained by a real space shooting unit configured to shoot a real space; and
a shooting control unit configured to control a shooting setting of the real space shooting unit in accordance with an operation instruction made by a user through an avatar in the virtual space.

2. The image processing apparatus according to claim 1, further comprising a virtual space shooting unit configured to obtain a part of the virtual space as a virtual camera image,
wherein the operation instruction is an instruction regarding a shooting setting for the virtual space shooting unit.

3. The image processing apparatus according to claim 1, wherein the shooting setting includes a setting pertaining to a brightness of an image.

4. The image processing apparatus according to claim 1, wherein the shooting setting includes a setting for image processing pertaining to at least one of a color, a tone, and an image range of an image.

5. The image processing apparatus according to claim 2, wherein the shooting control unit controls a shooting setting of the real space shooting unit so as to correspond to the shooting setting instructed for the virtual space shooting unit.

6. The image processing apparatus according to claim 2, further comprising a switching unit configured to switch between enabling and disabling changing the shooting setting of the real space shooting unit and the shooting setting of the virtual space shooting unit in coordination with each other, the changing being performed in accordance with an operation instruction from the user,
wherein in a case where the changing in coordination is enabled, the shooting control unit changes the shooting setting of the virtual space shooting unit and the shooting setting of the real space shooting unit in coordination with each other in response to the operation instruction, and in a case where the changing in coordination is disabled, the shooting control unit does not change the shooting setting of the real space shooting unit in coordination with the shooting setting of the virtual space shooting unit in response to the operation instruction.

7. The image processing apparatus according to claim 2, wherein the shooting control unit includes a switching unit configured to switch to one of controlling the shooting setting of the virtual space shooting unit and the shooting setting of the real space shooting unit, controlling the shooting setting of only the virtual space shooting unit, and controlling the shooting setting of only the real space shooting unit, in response to instruction of the shooting setting for the virtual space shooting unit.

8. The image processing apparatus according to claim 6, further comprising a determining unit configured to determine whether the display region is within an angle of view of the virtual space shooting unit,
wherein the shooting control unit does not control shooting setting of the real space shooting unit in a case where the display region is determined not to be within the angle of view.

9. The image processing apparatus according to claim 6, further comprising a determining unit configured to determine whether the shooting setting of the real space shooting unit is controllable,
wherein the shooting control unit does not control the shooting setting of the real space shooting unit in a case where it is determined that the shooting setting is not controllable.

10. The image processing apparatus according to claim 1, further comprising a virtual space image generating unit configured to generate a viewing image for viewing the virtual space,
wherein the virtual space image generating unit changes image processing to be performed on the display region for displaying the real space image within the viewing image, in accordance with control of the shooting setting of the real space shooting unit.

11. The image processing apparatus according to claim 10, wherein in the image processing performed on the display region, the display region is processed so as to reduce a change in the real space image that occurred in accordance with control of the shooting setting for the real space shooting unit.

12. The image processing apparatus according to claim 2, further comprising a display unit configured to display information pertaining to an image shot by at least one of the real space shooting unit and the virtual space shooting unit.

13. The image processing apparatus according to claim 12, wherein the information pertaining to the image includes information on a brightness of the image.

14. The image processing apparatus according to claim 12, wherein the information pertaining to the image includes information on blown-out highlight or blocked-up shadow in the image.

15. An image processing method comprising:
generating a virtual space including a display region of a real space image, the real space image being obtained by a real space shooting unit configured to shoot a real space; and
controlling a shooting setting of the real space shooting unit in accordance with an operation instruction made by a user through an avatar in the virtual space.

16. A non-transitory computer-readable storage medium which stores a program for causing a computer to execute an image processing method comprising:
generating a virtual space including a display region of a real space image, the real space image being obtained by a real space shooting unit configured to shoot a real space; and
controlling a shooting setting of the real space shooting unit in accordance with an operation instruction made by a user through an avatar in the virtual space.
